(19) United States
(12) Patent Application Publication
(10) Pub. No.: US 2021/0174766 A1
(43) Pub. Date: Jun. 10, 2021

(54) ELECTRONIC DEVICE FOR CONTROLLING DIVIDED SCREEN

(71) Applicant: Samsung Electronics Co., Ltd., Gyeonggi-do (KR)

(72) Inventors: Jinkyo CHUNG, Gyeonggi-do (KR); Sukjae LEE, Gyeonggi-do (KR)

(21) Appl. No.: 17/270,329

(22) PCT Filed: Aug. 7, 2019
(86) PCT No.: PCT/KR2019/009835

§ 371 Date: Feb. 22, 2021

(30) Foreign Application Priority Data
Aug. 23, 2018 (KR) 10-2018-0098318

(51) Int. Cl. G09G 5/14; G06F 3/0488; G06F 3/0482; G06F 1/16

(52) U.S. Cl. CPC G09G 5/14; G06F 3/0488; G09G 2354/00; G06F 1/1641; G06F 2203/04803; G06F 3/0482

(57) ABSTRACT

An electronic device according to an embodiment disclosed in the present disclosure may include a housing, a display disposed inside the housing and including a first region and a second region extending from the first region, a first sensor disposed at an edge of the housing and measuring an inclined angle between the first region and the second region, a second sensor detecting whether or not one surface of the housing is in contact with an external object, and a processor electrically connected to the display, the first sensor, and the second sensor, and the processor may turn on the first region and turn off the second region if the angle is within a specified range and the one surface of the housing contacts the external object. In addition to the above, various embodiments identified through the specification are possible.

### TECHNICAL FIELD

Embodiments disclosed in the present disclosure relate to a technique for dividing a screen in a folding electronic device for using the screen.

### BACKGROUND ART

With the recent increase of demands for larger screens, the development of a technique for an electronic device capable of providing a large screen to a user has been actively conducted. For example, when a full front display is mounted in an electronic device, a user is able to use the entire front surface of the electronic device as a display, and is able to enjoy photos, videos, and the like, through a larger screen accordingly.

Despite the advantage of being able to enjoy photos, videos, and the like, through the larger screens, as the size of the display gradually increases, it may not be easier for a user to carry the electronic device. For example, if the size of the display is larger than a certain size, it is not easy to hold it in one hand and not easy to fit it into a pocket, or the like, which may make the user inconvenient. Accordingly, in recent years, the development of a technique for an electronic device capable of being folded to a certain size or less has been actively conducted.

### DISCLOSURE OF THE INVENTION

### Technical Problem

When the electronic device is folded to a certain size or less, the screen output through the display is also folded together with the electronic device, and thus the user may not be able to easily recognize the screen output on a partial region of the display. For example, when the user folds the electronic device, an angle of the partial region made with the line of sight of the user is parallel or equal to or less than a certain angle, and as a result, the user may not be able to easily recognize the partial region. Accordingly, the user may not be able to recognize the information output through the partial region, which may be inconvenient.

Embodiments disclosed in the present disclosure are to provide an electronic device for solving the aforementioned problems and the problems posed in the present disclosure.

### Technical Solution

According to an aspect of the present disclosure, there may be provided an electronic device including a housing, a display disposed inside the housing and including a first region and a second region extending from the first region, a first sensor disposed at an edge of the housing and measuring an inclined angle between the first region and the second region, a second sensor detecting whether or not one surface of the housing is in contact with an external object, and a processor electrically connected to the display, the first sensor, and the second sensor, and the processor may turn on the first region and turn off the second region if the angle is within a specified range and the one surface of the housing contacts the external object.

According to another aspect of the present disclosure, there may be provided an electronic device including a housing, a display disposed inside the housing and including a first region and a second region extending from the first region, a first sensor disposed at an edge of the housing and measuring an inclined angle between the first region and the second region, a second sensor detecting whether or not one surface of the housing is in contact with an external object, and a processor electrically connected to the display, the first sensor, and the second sensor, and the processor may output, through the display a first icon for turning on the first region and turning off the second region if the angle is within a specified range and the one surface of the housing contacts the external object.

According to an aspect of the present disclosure, there may be provided an electronic device including a housing, a display disposed inside the housing and including a first region and a second region extending from the first region, a first sensor disposed at an edge of the housing and measuring an inclined angle between the first region and the second region, a second sensor detecting whether or not one surface of the housing is in contact with an external object, and a processor electrically connected to the display, the first sensor, and the second sensor, and the processor may turn on the first region and turn off the second region if the angle is within a specified range.

### Advantageous Effects

According to the embodiments disclosed in the present disclosure, it is possible to improve user convenience.

Besides, various effects may be provided that are directly or indirectly identified through the present disclosure.

### BRIEF DESCRIPTION OF THE DRAWINGS

FIG. 1 is a diagram illustrating an electronic device in an unfolded state according to an embodiment;

FIG. 2 is a diagram illustrating the electronic device in a folded state according to an embodiment;

FIG. 3 is a diagram illustrating components included in the electronic device according to an embodiment;

FIG. 4 is a diagram illustrating an electronic device in an unfolded state according to another embodiment;

FIG. 5 is a diagram illustrating the electronic device in a folded state according to another embodiment;

FIG. 6 is a diagram illustrating a screen output state of the electronic device according to another embodiment;

FIG. 7 is a diagram illustrating an electronic device in an unfolded state according to yet another embodiment;

FIG. 8 is a diagram illustrating a screen output state of the electronic device by a first icon according to yet another embodiment;

FIG. 9 is a diagram illustrating a screen output state of the electronic device by a second icon according to yet another embodiment;

FIGS. 10 and 11 are diagrams illustrating a state of outputting a control screen through a partial region of a display by an electronic device according to various embodiments; and

FIG. 12 is a block diagram of an electronic device in a network environment according to various embodiments.

### MODE FOR CARRYING OUT THE INVENTION

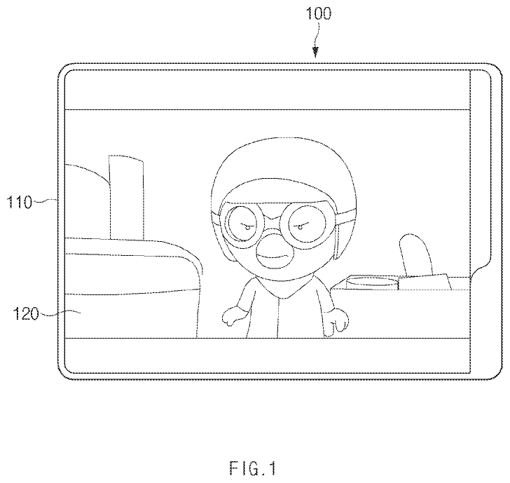

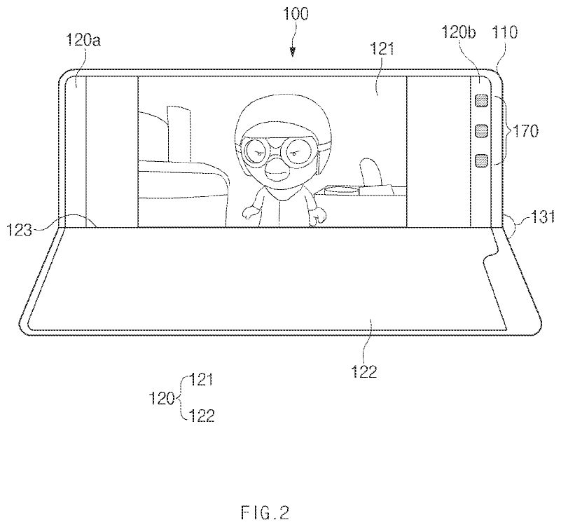

FIG. 1 is a diagram illustrating an electronic device in an unfolded state according to an embodiment. FIG. 2 is a diagram illustrating the electronic device in a folded state according to an embodiment. FIG. 2 illustrates a state in which an electronic device 100 illustrated in FIG. 1 is folded by a user.

Referring to FIG. 1, the electronic device 100 may include a housing 110 and a display 120.

The housing 110 may protect various parts (e.g., the display 120) included in the electronic device 100 from external impacts by forming the exterior of the electronic device 100. According to an embodiment, the housing 110 may be made of metal, plastic, or a bendable polymer material.

The display 120 may be disposed inside the housing 110. The display 120 may output various contents in response to a user input. For example, if the user executes a gallery application, the display 120 may output various photos.

Referring to FIG. 2, the electronic device 100 may be folded based on a boundary line 123. For example, if the user pushes one surface of the housing 110 while holding the electronic device 100, the electronic device 100 may be folded as illustrated in FIG. 2.

According to an embodiment, the housing 110 and the display 120 may also be folded based on the boundary line 123. Although not illustrated in FIG. 2, the housing 110 may include regions separated to be folded based on the boundary line 123 when the user pushes the electronic device 100. The display 120 may include a first region 121 and a second region 122 extending from the first region 121. The first region 121 and the second region 122 are regions separated based on the boundary line 123, and the display 120 may display different screens through the first region 121 and the second region 122.

According to an embodiment, the electronic device 100 may turn on the first region 121 and turn off the second region 122 if the angle 131 between the first region 121 and the second region 122 is within a specified range (e.g., 90° to 170°). Since the first region 121 is turned on, an application execution screen, a photo, and so on, may be output through the first region 121. Since the second region 122 is turned off, an application execution screen, a photo, and so on, may not be output through the second region 122. The electronic device 100 according to an embodiment of the present disclosure may output a screen through a partial region of the display in a state in which the electronic device 100 is folded. Accordingly, the output screen may be within a range where it is easily visible to a user, which may lead to greater user convenience.

According to an embodiment, the electronic device 100 may turn on the first region 121 and turn off the second region 122, if the angle 131 between the first region 121 and the second region 122 is within a specified range (e.g., 90° to 170°) and one surface of the housing 110 (e.g., surface opposite to the second region 122) contacts an external object (e.g., table). For example, if the user puts the electronic device 100 on a table in a state in which the electronic device 100 is folded at a certain angle 131, the electronic device 100 may turn on the first region 121 and turn off the second region 122. The electronic device 100 according to an embodiment of the present disclosure may output a screen through a partial region of the display 120. Accordingly, the output screen may be within a range where it is easily visible to a user, which may lead to greater user convenience.

According to an embodiment, a hinge coupling the first region 121 and the second region 122 may be disposed on the boundary line 123. The hinge may fix the first region 121 and the second region 122 such that the angle between the first region 121 and the second region 122 are kept constant. For example, if the user folds the electronic device 100 until the angle 131 between the first region 121 and the second region 122 is 90°, the hinge may fix the first region 121 and the second region 122 such that the angle 131 between the first region 121 and the second region 122 is 90°.

According to an embodiment, the electronic device 100 may turn on the first region 121 and turn off the second region 122 if the angle between the first region 121 and the second region 122 is within a specified range (e.g., 90° to 170°). In this case, the electronic device 100 may output icons 170 on an upper region 120b of the display 120 by turning on the first region 121.

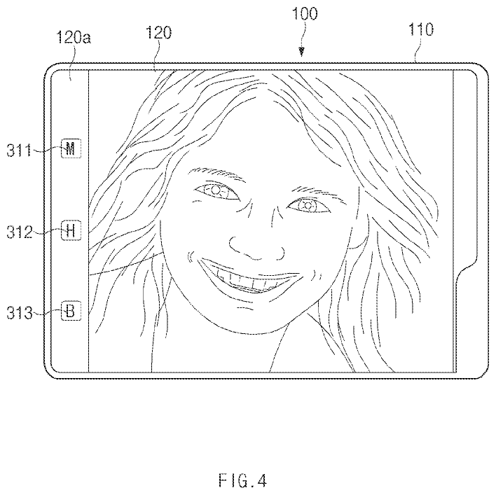

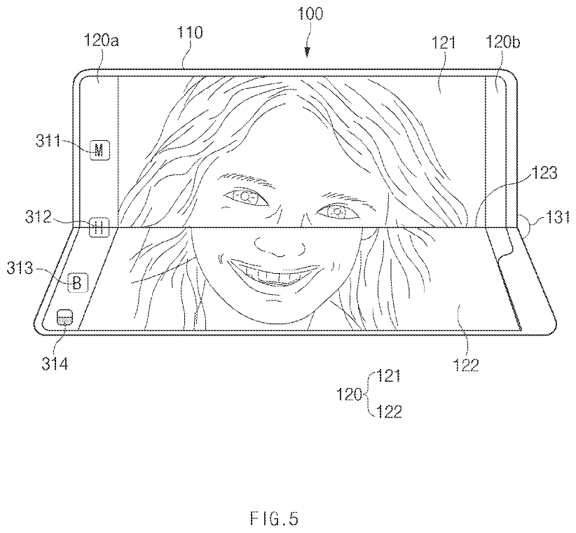

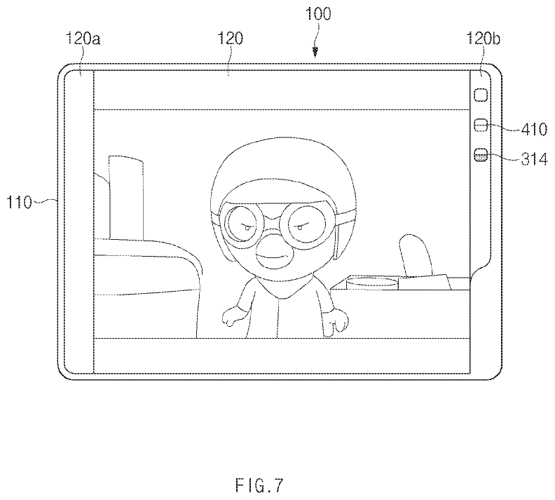

According to another embodiment, the electronic device 100 may turn on the first region 121 and turn off the second region 122, if the angle 131 between the first region 121 and the second region 122 is within a specified range (e.g., 90° to 170°) and one surface of the housing 110 (e.g., surface opposite to the second region 122) contacts an external object (e.g., table). In this case, the electronic device 100 may output icons 170 on an upper region 120b of the display 120 by turning on the first region. The positions of the icons 170 illustrated in FIG. 2 are exemplary, and the icons 170 may be output on a lower region 120a of the display 120. In addition, the icons 170 illustrated in FIG. 2 may be referred to as any one of a menu key (311 in FIG. 4), a home key (312 in FIG. 4), a back key (313 in FIG. 4), and a first icon (314 in FIG. 5), and a second icon (410 in FIG. 7), which will be described below.

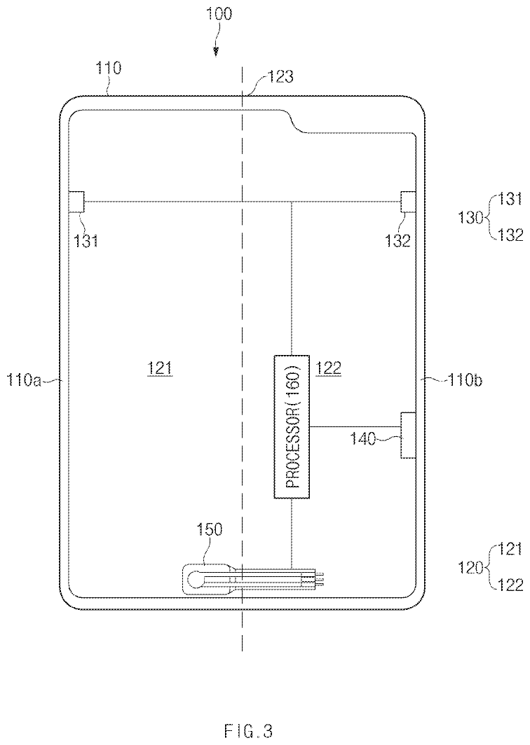

FIG. 3 is a diagram illustrating components included in the electronic device according to an embodiment.

Referring to FIG. 3, the electronic device 100 may perform the operations described in FIGS. 1 and 2 through the components illustrated in FIG. 3. According to an embodiment, the electronic device 100 may include a first sensor 130, a second sensor 140, a third sensor 150, and a processor 160.

The first sensor 130 may measure the angle 131 between the first region 121 and the second region 122. For example, the first sensor 130 may include a first measurement member 131 and a second measurement member 132. The first measurement member 131 may be disposed on a first edge 110a of the housing 110, and the second measurement member 132 may be disposed on a second edge 110b of the housing 110. When the electronic device 100 is folded, the first measurement member 131 and the second measurement member 132 may become closer to each other in distance, and the first sensor 130 may measure the angle 131 between the first region 121 and the second region 122 based on the distance between the first measurement member 131 and the second measurement 132. In the present disclosure, the first sensor 130 may be referred to as a 6-axis sensor.

The second sensor 140 may determine whether or not one surface of the housing 110 (e.g., surface opposite to the second region 122) contacts an external object (e.g., table). For example, if one surface of the housing 110 (e.g., surface opposite to the second region 122) contacts a table in a state in which the electronic device 100 is folded, the second sensor 140 may determine that the electronic device 100 contacts the external object. For another embodiment, the second sensor 140 may be disposed on the first edge 110a of the housing 110, and in this case, may determine whether or not the other surface of the housing 110 (e.g., surface opposite to the first region 121) contacts an external terminal (e.g., table). In the present disclosure, the second sensor 140 may be referred to as a touch sensor.

The third sensor 150 may measure the pressure applied to the housing 110. The third sensor 150 may output the degree of pressure applied to the housing 110 through a gauge. For example, the third sensor 150 may adjust the size of the gauge in proportion to the size of the pressure applied to the housing 110.

The processor 160 may be electrically connected to the first sensor 130, the second sensor 140, the third sensor 150, and the display 120. According to an embodiment, the processor 160 may measure the angle 131 of the first region 121 to the second region 122 through the first sensor 130, and may turn on the first region 121 and turn off the second region 122 if the measured angle 131 is within a specified range (e.g., 90° to 170°). Since the first region 121 is turned on, an application execution screen, a photo, and so on, may be output through the first region 121. Since the second region 122 is turned off, an application execution screen, a photo, and so on, may not be output through the second region 122. The electronic device 100 according to an embodiment of the present disclosure may output a screen through a partial region in a state in which the electronic device 100 is folded. Accordingly, the output screen may be within a range where it is easily visible to a user, which may lead to greater user convenience.

According to an embodiment, the processor 160 may determine through the second sensor 140 whether or not one surface of the housing 110 (e.g., surface opposite to the second region 122) contacts an external object (e.g., table). For example, if the angle 131 between the first region 121 and the second region 122 is within a specified range (e.g., 90° to 170°) and one surface of the housing 110 (e.g., surface opposite to the second region 122) contacts an external object (e.g., table), the electronic device 100 may turn on the first region 121 and turn off the second region 122. The electronic device 100 according to an embodiment of the present disclosure may output a screen through a partial region in the display 120. Accordingly, the output screen may be within a range where it is easily visible to a user, which may lead to greater user convenience.

According to an embodiment, the processor 160 may measure the pressure applied to the housing 110 through the third sensor 150.

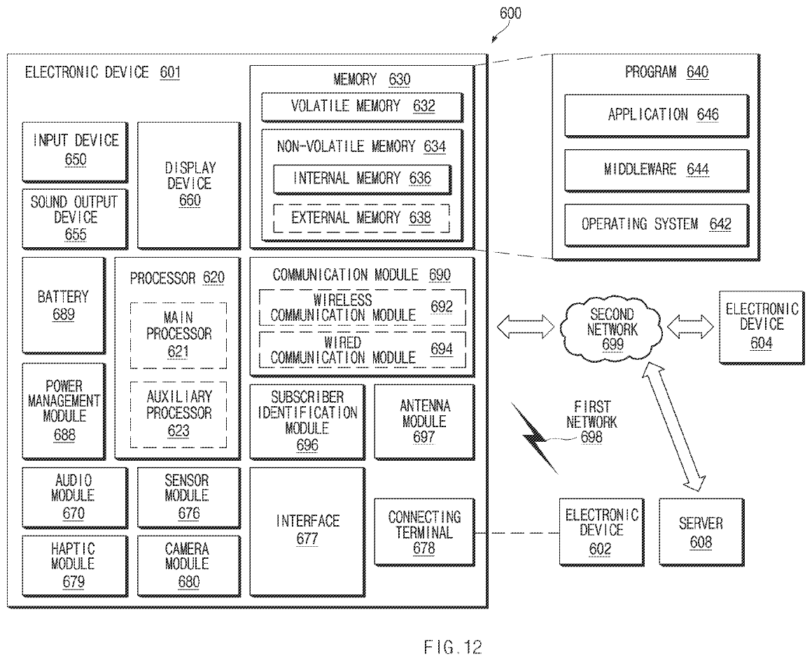

In the present disclosure, the processor 160 may be referred to as the application processor 160 (application processor; AP) and/or a processor 620 illustrated in FIG. 12. In addition, in the present disclosure, components having the same reference numerals as the electronic device 100 described in FIGS. 1 and 3 may be described as the same contents of FIGS. 1 and 3.

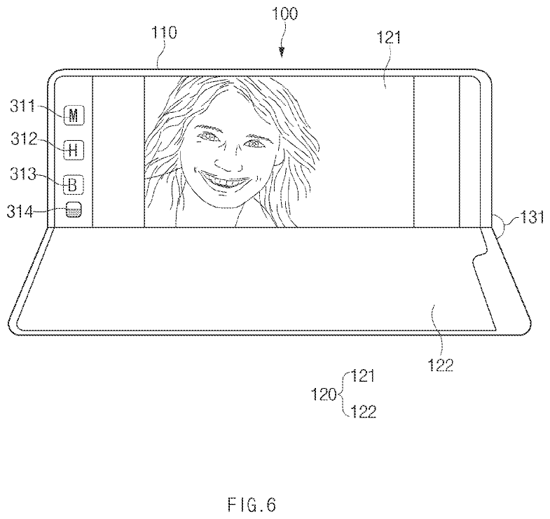

FIG. 4 is a diagram illustrating an electronic device in an unfolded state according to another embodiment. FIG. 5 is a diagram illustrating the electronic device in a folded state according to another embodiment. FIG. 6 is a diagram illustrating a screen output state of the electronic device according to another embodiment.

FIG. 5 illustrates a state in which the electronic device 100 illustrated in FIG. 4 is folded, and FIG. 6 illustrates the screen output state when a user touches a first icon 314 illustrated in FIG. 5.

Referring to FIG. 4, the electronic device 100 may output various types of content through the display 120. In the present disclosure, the content may refer to an image, a video, an icon, and the like, output through the display 120.

According to another embodiment, the electronic device 100 may output the menu key 311, the home key 312, and the back key 313 through the lower region 120a of the display 120. The menu key 311 may refer to an icon capable of outputting a list of various applications running in the electronic device 100. The home key 312 may refer to an icon capable of calling a home screen. The back key 313 may refer to an icon capable of controlling the electronic device 100 to return to the immediately previous execution state.

Referring to FIG. 5, the electronic device 100 may be folded based on the boundary line 123. For example, if the user pushes one surface of the housing 110 while holding the electronic device 100, the electronic device 100 may be folded as illustrated in FIG. 5.

According to another embodiment, the electronic device 100 may output the first icon 314 on the lower region 120a of the display 120 if the angle 131 between the first region 121 and the second region 122 is within a specified range (e.g., 90° to 170°). The position of the first icon 314 illustrated in FIG. 5 is exemplary, and the first icon 314 may be output through the upper region 120b of the display 120. The first icon 314 may be output on the region 120a in which the menu key 311, the home key 312, and the back key 313 are positioned. When the user touches the first icon 314 in a state in which the first icon 314 is displayed, the electronic device 100 may turn on the first region 121 and turn off the second region 122, as illustrated. in FIG. 6. Since the first region 121 is turned on, an application execution screen, a photo, and so on, may be output through the first region 121. Since the second region 122 is turned off, an application execution screen, a photo, and so on, may not be output through the second region 122. When the electronic device 100 is folded, the electronic device 100 according to another embodiment of the present disclosure may output the first icon 314 through the display 120. In this case, when the user touches the first icon 314, a screen may be output through a partial region. Accordingly, the output screen may be within a range where it is easily visible to a user, which may lead to greater user convenience.

According to another embodiment, the electronic device 100 may output the first icon 314 on the lower region 120a of the display 120 if the angle 131 between the first region 121 and the second region 122 is within a specified range (e.g., 90° to 170°) and one surface of the housing 110 contacts an external object (e.g., table). The first icon 314 may be output on the region 120a in which the menu key 311, the home key 312, and the back key 313 are positioned. When the user touches the first icon 314 in a state in which the first icon 314 is displayed, the electronic device 100 may turn on the first region 121 and turn off the second region 122, as illustrated in FIG. 6. Since the first region 121 is turned on, an application execution screen, a photo, and so on, may be output through the first region 121. Since the second region 122 is turned off, an application execution screen, a photo, and so on, may not be output through the second region 122. The electronic device 100 according to another embodiment of the present disclosure may output the first icon 314 through the display 120 if one surface of the housing 110 contacts an external object in a state in which the electronic device 100 is folded. The user may view the screen through a partial region by touching the first icon 314. According to another embodiment of the present disclosure, the output screen may be within a range where it is easily visible to a user, which may lead to greater user convenience.

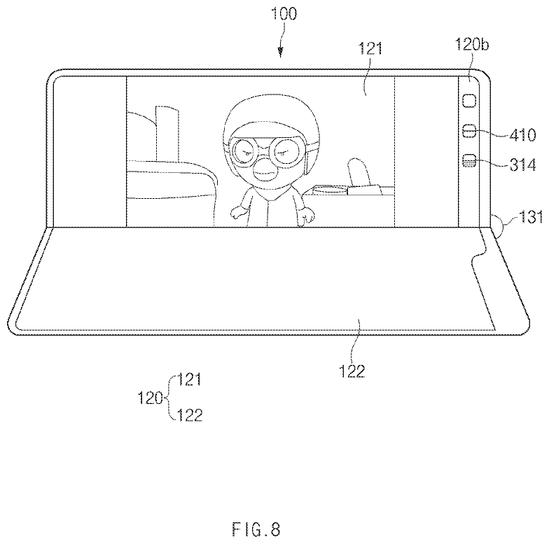

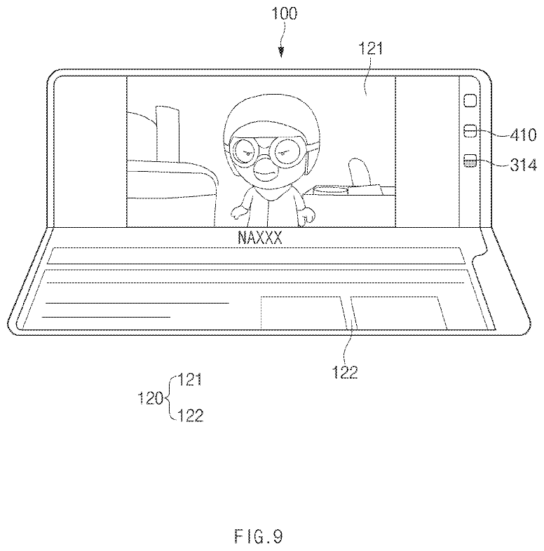

FIG. 7 is a diagram illustrating an electronic device in an unfolded state according to yet another embodiment. FIG. 8 is a diagram illustrating a screen output state of the electronic device by a first icon according to yet another embodiment. FIG. 9 is a diagram illustrating a screen output state of the electronic device by a second icon according to yet another embodiment.

FIG. 8 illustrates a screen output state when the user touches the first icon 314 illustrated in FIG. 7, and FIG. 9 illustrates a screen output state when the user touches the second icon 410 illustrated in FIG. 7.

Referring to FIG. 7, the electronic device 100 may output the first icon 314 and the second icon 410 through the upper region 120b of the display 120. In this case, the menu key 311, the home key 312, and the back key 313 may be output to the lower region 120a, and may be output through the upper region 120b together with the first icon 314 and the second icon 410. The positions of the first icon 314 and the second icon 410 illustrated in FIG. 7 are exemplary, and the first icon 314 and the second icon 410 may be output to the upper region 120b or the lower region 120a. For another example, the electronic device 100 may output the first icon 314 and the second icon 410 through the upper region 120b of the display 120 if the angle 131 between the first region 121 and the second region 122 is within a specified range (e.g., 90° to 170°). For another example, the electronic device 100 may output the first icon 314 and the second icon 410 if the angle 131 between the first region 121 and the second region 122 is within a specified range (e.g., 90° to 170°) and one surface of the housing 110 contacts an external object (e.g., table).

According to another embodiment, when the user touches the first icon 314 in a state in which the first icon 314 and the second icon 410 are output through the upper region 120b of the display 120, the electronic device 100 may turn on the first region 121 and turn off the second region 122, as illustrated in FIG. 8. Since the first region 121 is turned on, an application execution screen, a photo, and so on, may be output through the first region 121. Since the second region 122 is turned off, an application execution screen, a photo, and so on, may not be output through the second region 122.

According to another embodiment, when the user touches the second icon 410 in a state in which the first icon 314 and the second icon 410 are output through the upper region 120b of the display 120, the electronic device 100 may output different screens on the first region 121 and the second region 122, as illustrated in FIG. 9. For example, the electronic device 100 may output a gallery application execution screen through the first region 121, and may output an Internet browser execution screen through the second region 122.

According to another embodiment, when the user touches the second icon 410 in a state in which the first icon 314 and the second icon 410 are output through the upper region 120b of the display 120, the electronic device 100 may output different screens on the first region 121 and the second region 122. For example, the electronic device 100 may output an application execution screen through the first region 121, and may output an application list through the second region 122. The electronic device may output the selected application execution screen through the second region 122 in response to a user input for selecting the application list.

According to another embodiment of the present disclosure, a user may turn off a partial region of the display 120 or output different screens through the first region and the second region, which may lead to greater user convenience.

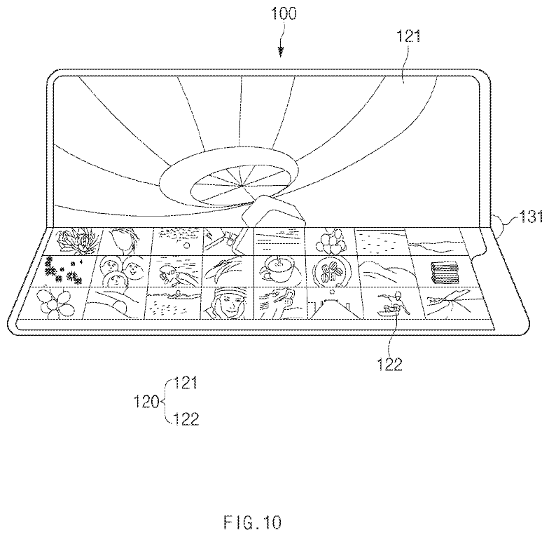

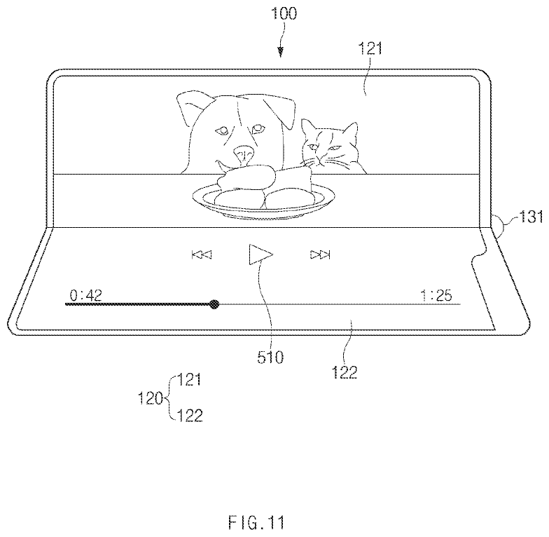

FIGS. 10 and 11 are diagrams illustrating a state of outputting a control screen through a partial region of a display by an electronic device according to various embodiments.

Referring to FIGS. 10 and 11, the electronic device 100 may output, through the second region 122, a control screen by which the first region 121 is controllable. For example, as illustrated in FIG. 10, an image list may be output on the second region 122. The user may select any one in the image list, and an image selected by the user may be output on the first region 121. For another example, as illustrated in FIG. 11, a video control screen may be output on the second region 122. When the user presses a play button 510 on the image control screen, the video may be played through the first region 121.

According to various embodiments, the electronic device 100 may output, through the second region 122, the control screen by which the first region 121 is controllable if the angle 131 between the first region 121 and the second region 122 is within a specified range (e.g., 90° to 170°). For example, the image list may be output on the second region 122, as illustrated in FIG. 10, if the angle 131 between the first region 121 and the second region 122 is within a specified range (e.g., 90° to 170°). The user may select any one in the image list, and an image selected by the user may be output on the first region 121.

According to various embodiments, the electronic device 100 may output, through the second region 122, the control screen by which the first region 121 is controllable, if the angle 131 between the first region 121 and the second region 122 is within a specified range (e.g., 90° to 170°) and one surface of the housing 110 contacts an external object (e.g., table). For example, the image list may be output on the second region 122, as illustrated in FIG. 10, if the angle 131 between the first region 121 and the second region 122 is within a specified range (e.g., 90° to 170°) and one surface of the housing 110 contacts an external object (e.g., table). The user may select any one in the image list, and an image selected by the user may he output on the first region 121,

[symbol]

An electronic device according to an embodiment of the present disclosure may include a housing, a display disposed inside the housing and including a first region and a second region extending from the first region, a first sensor disposed at an edge of the housing and measuring an inclined angle between the first region and the second region, a second sensor detecting whether or not one surface of the housing is in contact with an external object, and a processor electrically connected to the display, the first sensor, and the second sensor, and the processor may turn on the first region and turn off the second region if the angle is within a specified range and the one surface of the housing contacts the external object.

The processor according to an embodiment of the present disclosure may output a first icon to a specified region of the display if the angle is within the specified range and the one surface of the housing contacts the external object, and may turn on the first region and turn off the second region in response to a first user input for touching the first icon.

The processor according to an embodiment of the present disclosure may output a second icon to the specified region, and may output different application execution screens to the first region and the second region in response to a second user input for touching the second icon.

The processor according to an embodiment of the present disclosure may output an application list to the second region, and may output a selected application execution screen through the second region in response to a third user input for selecting any one in the application list.

The processor according to an embodiment of the present disclosure may output a home key, a back key, and a menu key to the specified region.

The processor according to an embodiment of the present disclosure may be configured to output an application execution screen through the first region by reducing the application execution screen if the angle is within the specified range in a state in which the application execution screen is being output through the display and the one surface of the housing contacts the external object.

The processor according to an embodiment of the present disclosure may be configured to output, through the second region, a control screen by which the first region is controllable,

The electronic device according to an embodiment of the present disclosure may further include a hinge supporting the first region and the second region such that the inclined angle between the first region and the second region is maintained.

An electronic device according to an embodiment of the present disclosure may include a housing, a display disposed inside the housing and including a first region and a second region extending from the first region, a first sensor disposed at an edge of the housing and measuring an inclined angle between the first region and the second region, a second sensor detecting whether or not one surface of the housing is in contact with an external object, and a processor electrically connected to the display, the first sensor, and the second sensor, and the processor may output, through the display, a first icon for turning on the first region and turning off the second region if the angle is within a specified range and the one surface of the housing contacts the external object.

The processor according to an embodiment of the present disclosure may turn on the first region and turn off the second region in response to a first user input for touching the first icon.

The processor according to an embodiment of the present disclosure may output a second icon to the display, and may output different application execution screens to the first region and the second region in response to a second user input for touching the second icon.

The processor according to an embodiment of the present disclosure may output an application list to the second region, and may output a selected application execution screen through the second region in response to a third user input for selecting any one in the application list.

The processor according to an embodiment of the present disclosure may output a home key, a back key, and a menu key to the display.

The processor according to an embodiment of the present disclosure may be configured to output an application execution screen through the first region by reducing the application execution screen if the angle is within the specified range in a state in which the application execution screen is being output through the display and the one surface of the housing contacts the external object.

The processor according to an embodiment of the present disclosure may be configured to output, through the second region, a control screen by which the first region is controllable.

The electronic device according to an embodiment of the present disclosure may further include a hinge supporting the first region and the second region such that the inclined angle between the first region and the second region is maintained.

An electronic device according to an embodiment of the present disclosure may include a housing, a display disposed inside the housing and including a first region and a second region extending from the first region, a first sensor disposed at an edge of the housing and measuring an inclined angle between the first region and the second region, a second sensor detecting whether or not one surface of the housing is in contact with an external object, and a processor electrically connected to the display, the first sensor, and the second sensor, and the processor may turn on the first region and turn off the second region if the angle is within a specified range.

The processor according to an embodiment of the present disclosure may turn on the first region and turn off the second region if the one surface of the housing contacts the external object.

The processor according to an embodiment of the present disclosure may output a first icon to a specified region of the display if the angle is within the specified range and the one surface of the housing contacts the external object, and may turn on the first region and turn off the second region in response to a first user input for touching the first icon.

The electronic device according to an embodiment of the present disclosure may further include a pressure sensor that measures a pressure applied to the housing.

[symbol]

### Mode for Invention

FIG. 12 is a block diagram illustrating an electronic device 601 in a network environment 600 according to various embodiments.

Referring to FIG. 12, the electronic device 601 in the network environment 600 may communicate with an electronic device 602 via a first network 698 (e.g., a short-range wireless communication network), or an electronic device 604 or a server 608 via a second network 699 (e.g., a long-range wireless communication network). According to an embodiment, the electronic device 601 may communicate with the electronic device 604 via the server 608. According to an embodiment, the electronic device 601 may include a processor 620, memory 630, an input device 650, a sound output device 655, a display device 660, an audio module 670, a sensor module 676, an interface 677, a haptic module 679, a camera module 680, a power management module 688, a battery 689, a communication module 690, a subscriber identification module(SIM) 696, or an antenna module 697. In some embodiments, at least one (e.g., the display device 660 or the camera module 680) of the components may be omitted from the electronic device 601, or one or more other components may be added in the electronic device 601. In some embodiments, some of the components may be implemented as single integrated circuitry. For example, the sensor module 676 (e.g., a fingerprint sensor, an iris sensor, or an illuminance sensor) may be implemented as embedded in the display device 660 (e.g., a display).

The processor 620 may execute, for example, software (e.g., a program 640) to control at least one other component a hardware or software component) of the electronic device 601 coupled with the processor 620, and may perform various data processing or computation. According to one embodiment, as at least part of the data processing or computation, the processor 620 may load a command or data received from another component (e.g., the sensor module 676 or the communication module 690) in volatile memory 632, process the command or the data stored in the volatile memory 632, and store resulting data in non-volatile memory 634. According to an embodiment, the processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or to be specific to a specified function. The auxiliary processor 623 may be implemented as separate from, or as part of the main processor 621.

The auxiliary processor 623 may control at least some of functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). According to an embodiment, the auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634.

The program 640 may be stored in the memory 630 as software, and may include, for example, an operating system (OS) 642, middleware 644, or an application 646.

The input device 650 may receive a command or data to be used by other component (e.g., the processor 620) of the electronic device 601, from the outside (e.g., a user) of the electronic device 601. The input device 650 may include, for example, a microphone, a mouse, a keyboard, or a digital pen (e.g., a. stylus pen).

The sound output device 655 may output sound signals to the outside of the electronic device 601. The sound output device 655 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. According to an embodiment, the display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. According to an embodiment, the audio module 670 may obtain the sound via the input device 650, or output the sound via the sound output device 655 or a headphone of an external electronic device (e.g., an electronic device 602) directly (e.g., wiredly) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. According to an embodiment, the sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device (e.g., the electronic device 602) directly (e.g., wiredly) or wirelessly. According to an embodiment, the interface 677 may include, for example, a high definition multimedia interface (HDMI), a universal serial bus (USB) interface, a secure digital (SD) card interface, or an audio interface.

A connecting terminal 678 may include a connector via which the electronic device 601 may be physically connected with the external electronic device (e.g., the electronic device 602). According to an embodiment, the connecting terminal 678 may include, for example, a HDMI connector, a USB connector, a SD card connector, or an audio connector (e.g., a headphone connector).

The haptic module 679 may convert an electrical signal into a mechanical stimulus (e.g., a vibration or a movement) or electrical stimulus which may be recognized by a user via his tactile sensation or kinesthetic sensation. According to an embodiment, the haptic module 679 may include, for example, a motor, a piezoelectric element, or an electric stimulator.

The camera module 680 may capture a still image or moving images. According to an embodiment, the camera module 680 may include one or more lenses, image sensors, image signal processors, or flashes.

The power management module 688 may manage power supplied to the electronic device 601. According to one embodiment, the power management module 688 may be implemented as at least part of, for example, a power management integrated circuit (PMIC).

The battery 689 may supply power to at least one component of the electronic device 601. According to an embodiment, the battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 601, or the server 608) and performing communication via the established communication channel. The communication module 690 may include one or more communication processors that are operable independently from the processor 620 (e.g., the application processor (AP)) and supports a direct (e.g., wired) communication or a wireless communication. According to an embodiment, the communication module 690 may include a wireless communication module 692 a cellular communication module, a short-range wireless communication module, or a global navigation satellite system (GNSS) communication module) or a wired communication module 691 (e.g., a local area network (LAN) communication module or a power line communication (PLC) module). A corresponding one of these communication modules may communicate with the external electronic device via the first network 698 (e.g., a short-range communication network, such as Bluetooth™, wireless-fidelity (Wi-Fi) direct, or infrared data association (IrDA)) or the second network 699 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside the external electronic device) of the electronic device 601. According to an embodiment, the antenna module 697 may include an antenna including a radiating element composed of a conductive material or a conductive pattern formed in or on a substrate (e.g., PCB). According to an embodiment, the antenna module 697 may include a plurality of antennas. In such a case, at least one antenna appropriate for a communication scheme used in the communication network, such as the first network 698 or the second network 699, may be selected, for example, by the communication module 690 (e.g., the wireless communication module 692) from the plurality of antennas. The signal or the power may then be transmitted or received between the communication module 690 and the external electronic device via the selected at least one antenna. According to an embodiment, another component (e.g., a radio frequency integrated circuit (RFIC)) other than the radiating element may be additionally formed as part of the antenna module 697.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 601 and the external electronic device 604 via, the server 608 coupled with the second network 699. Each of the electronic devices 602 and 604 may be a device of a same type as, or a different type, from the electronic device 601. According to an embodiment, all or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 640) including one or more instructions that are stored in a storage medium (e.g., internal memory 636 or external memory 638) that is readable by a machine (e.g., the electronic device 601). For example, a processor (e.g., the processor 620) of the machine the electronic device 601) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly or heuristically, or one or more of the operations may be executed in a different order or omitted, or one or more other operations may be added.

[symbol]

[symbol]

1. An electronic device comprising:
housing;
a display disposed inside the housing and including a first region and a second region extending from the first region;
a first sensor disposed at an edge of the housing and measuring an inclined angle between the first region and the second region;
a second sensor detecting whether or not one surface of the housing is in contact with an external object; and
a processor electrically connected to the display, the first sensor, and the second sensor,
wherein the processor turns on the first region and turns off the second region if the angle is within a specified range and the one surface of the housing contacts the external object.

2. The electronic device of claim 1, wherein the processor:
outputs a first icon to a specified region of the display if the angle is within the specified range and the one surface of the housing contacts the external object; and
turns on the first region and turns off the second region in response to a first user input for touching the first icon.

3. The electronic device of claim 2, wherein the processor:
outputs a second icon to the specified region; and
outputs different application execution screens to the first region and the second region in response to a second user input for touching the second icon.

4. The electronic device of claim 3, wherein the processor outputs an application list to the second region, and outputs the selected application execution screen through the second region in response to a third user input for selecting any one in the application list.

5. The electronic device of claim 2, wherein the processor outputs a home key, a back key, and a menu key to the specified region.

6. The electronic device of claim 1, wherein the processor is configured to output an application execution screen through the first region by reducing the application execution screen if the angle is within the specified range in a state in which the application execution screen is being output through the display and the one surface of the housing contacts the external object.

7. The electronic device of claim 1, wherein the processor is configured to output, through the second region, a control screen by which the first region is controllable.

8. The electronic device of claim 1, further comprising a hinge supporting the first region and the second region such that the inclined angle between the first region and the second region is maintained.

9. An electronic device comprising:
a housing;
a display disposed inside the housing and including a first region and a second region extending from the first region;
a first sensor disposed at an edge of the housing and measuring an inclined angle between the first region and the second region;
a second sensor detecting whether or not one surface of the housing is in contact with an external object; and
a processor electrically connected to the display, the first sensor, and the second sensor,
wherein the processor outputs, through the display, a first icon for turning on the first region and turning off the second region if the angle is within a specified range and the one surface of the housing contacts the external object.

10. The electronic device of claim 9, wherein the processor turns on the first region and turns off the second region in response to a first user input for touching the first icon.

11. The electronic device of claim 10, wherein the processor:
outputs a second icon to the display; and
outputs different application execution screens to the first region and the second region in response to a second user input for touching the second icon.

12. The electronic device of claim 11, wherein the processor outputs an application list to the second region, and outputs the selected application execution screen through the second region in response to a third user input for selecting any one in the application list.

13. The electronic device of claim 9, wherein the processor outputs a home key, a back key, and a menu key to the display.

14. The electronic device of claim 9, wherein the processor is configured to output an application execution screen through the first region by reducing the application execution screen if the angle is within the specified range in a state in which the application execution screen is being output through the display and the one surface of the housing contacts the external object.

15. An electronic device comprising:
a housing;
a display disposed inside the housing and including a first region and a second region extending from the first region;
a first sensor disposed at an edge of the housing and measuring an inclined angle between the first region and the second region;
a second sensor detecting whether or not one surface of the housing is in contact with an external object; and
a processor electrically connected to the display, the first sensor, and the second sensor,
wherein the processor turns on the first region and turns off the second region if the angle is within a specified range.
